(19) United States
(12) Patent Application Publication
(10) Pub. No.: US 2010/0309163 A1
(43) Pub. Date: Dec. 9, 2010

(54) TOUCH PANEL WITH THE MATRIX-TYPE PARALLEL ELECTRODE SERIES

(75) Inventors: Herng-Ming Yeh, Taoyuan County (TW); Yi-Ta Chen, HsinChu (TW)

Correspondence Address: RABIN & Berdo, PC, 1101 14TH STREET, NW, SUITE 500, WASHINGTON, DC, 20005, US

(73) Assignee: Higgstec Inc., Taoyuan County (TW)

(21) Appl. No.: 12/792,173

(22) Filed: Jun. 2, 2010

(30) Foreign Application Priority Data
Jun. 3, 2009 (TW) 098118413

(51) Int. Cl. G06F 3/041

(52) U.S. Cl. 345/174

(57) ABSTRACT

The disclosure is related to a touch panel with the matrix-type parallel electrode series. It adopts the symmetrical parallel electrode series to form the M pairs of parallel electrode in x-axis and N pairs of pairs of parallel electrode in y-axis. Each of the parallel electrode series is formed by a parallel electrode, resistance, corner electrodes, and chain of series electrode. Therefore, the internal contact area of the conductive layer can be divided into MxN blocks. Using the voltage supply to the parallel electrode, the detection of different blocks on the conductive layer can be formed and further meet the purpose of detection of multiple touch points.

### CROSS-REFERENCES TO RELATED APPLICATIONS

This non-provisional application claims priority under 35 U.S.C. §119(a) on patent application Ser. No. 98118413 filed in Taiwan, R.O.C. on Jun. 3, 2009, the entire contents of which are hereby incorporated by reference.

### BACKGROUND

1. Technical Field

The disclosure relates to a touch panel, in particular, to a touch panel with the matrix-type parallel electrode series.

2. Related Art

Nowadays, the most popular touch panels sold in the market are generally classifiable as resistive-type and capacitive-type touch panels. The resistive-type also can be classified into 4-wire resistive-type, 5-wire resistive-type, 6-wire resistive-type and 8-wire resistive-type. The capacitive-type can be classified into surface capacitive touch screen (SCT) and projective capacitive touch screen (PCT) which is also referred to as digital-touch technology. The resistive-type and the surface capacitive touch screen (SCT) are generally referred to as analog-touch technology.

Nowadays, the most popular touch panel technology uses input control of the voltage supply of four points. In the control of the power input, detection is achieved using the input control of the voltage supply of four corners.

For example, the operation of the surface capacitive touch screen (SCT) involves a uniform electrical field formed on the Indium Tin Oxide (ITO) layer. The capacitance charge effect takes place when the fingers touch the panel. The capacitance coupled is formed between the transparent electrode and the fingers, producing the current variation. The current magnitude at the four corners is measured by the controller, and the touch position can then be calculated by measuring the current magnitude.

Please refer to FIG. 1, which is the structure of a 5-wire touch panel 10 in the prior art. The controlled circuit (not shown) is connected to the four electrodes A, B, C and D of the conductive layer 11 using the electrode line and the electrode plate of PA, PB, PC and PD, wherein the enclosure on the conductive layer by the four chains of series resistances CAR-YU, CARYD, CAR-XR and CAR-XL is the touch area. The four electrodes A, B, C and D form an uniform distribution of electrical field for the detection of the touch position of the resistive-type or the surface capacitive touch screen (SCT) using the four chains of series resistances CAR-YU, CARYD, CAR-XR, CAR-XL and the voltage control of the controlled circuit.

Please refer to FIG. 2 and FIG. 3, which are the schematic diagrams of controlled mode of detecting voltage in the y-axis and detecting voltage in the y-axis of the touch panel. Now please refer to FIG. 2, it a schematic diagram of the controlled mode of detecting voltage in the y-axis of the touch panel. As the voltage controlled unit input voltages to the electrode plates with PA=+5V, PB=0V, PC=0V and PD=+5V, the electrical field is generated within chains of series resistances, CAR-YU, CAR-YD, CAR-XR and CAR-XL around conductive layer 11. Please refer to FIG. 2, where the dash-line is the equi-potential line and the solid-line indicates the current direction. The touched position in y-axis can be detected as an object is contacting the touch panel. Please refer to FIG. 3, which is a schematic diagram of the controlled mode of detecting voltage in the x-axis of the touch panel. As the voltage controlled unit input voltages to the electrode plates with PA=+5V, PB=+5V, PC=0V and PD=0V, the electrical field is generated within chains of series resistances, CAR-YU, CAR-YD, CAR-XR and CAR-XL around conductive layer 11. Please refer to FIG. 3, where the dash-line is the equi-potential line and the solid-line indicates the current direction. The touched position in x-axis can be detected when an object contacts the touch panel.

The technology of the analog touch panel is precise within an error range about 1%. However, it can still used detect a single point. The detection of multiple touch points is not possible using present analog touch panel technology. In many applications, the detection of multiple touch points is a popular feature of touch technology. Moreover, the projective capacitive touch screen (PCT) is used as the touch panel when detecting multiple touch points is desired.

Analog touch panel technology is now relatively mature, and also possesses the advantage of mass production. If the detection of multiple touch points and high precision can be meet by an analog touch panel, the cost detecting multiple touch points on a touch panel can be reduced, making the application of a touch panels expand rapidly and widely.

### SUMMARY

Accordingly, the disclosure is directed to a touch panel with the matrix-type parallel electrode series, which can meet the purpose of detecting multiple touch points using an analog touch panel.

The following provides a touch panel with the matrix-type parallel electrode series, including: a substrate; a conductive layer formed on the substrate, the conductive layer including an internal contact area; at least one parallel electrode pair in x-axis, formed on the edges of both sides in x-axis direction of the conductive layer in series and with symmetry, the parallel electrodes in x-axis are connected to a voltage controlled unit; at least one parallel electrode pair in y-axis, defined at least one detecting area in y-axis, formed on the edges of both sides in y-axis of the conductive layer in series and with symmetry, the parallel electrodes in y-axis are connected to the voltage controlled unit; and a plurality of series electrode chains, formed on the conductive layer, the two terminals of each of the plurality of series electrode chains are connected to either the two terminals of at least one parallel electrode pair in x-axis or the two terminals of at least one parallel electrode pair in y-axis and enclosing the internal contact area, each of the plurality of series electrode chains includes a plurality of electrodes which possess an internal part and forms a gap between the plurality of electrodes; wherein the voltage controlled unit provides a voltage to at least one parallel electrode pair in x-axis and at least one parallel electrode pair in y-axis, and the voltage is transmitted by connecting the series electrode chains to at least one detecting area in x-axis and at least one detecting area in y-axis, and touch detection is then performed.

The following disclosure further provides a touch panel with the matrix-type parallel electrode series, including: a substrate; a conductive layer formed on the substrate, the conductive layer includes an internal contact area; a plurality of touch areas enclosed by at least one discontinuous isolated line in x-axis and at least one discontinuous isolated line in y-axis; a plurality of parallel electrode pairs in x-axis, formed on the edges of both sides in x-axis direction of the conductive layer in series and with symmetry, connected to a voltage controlled unit, defining the plurality of touch areas as a plurality of x-axis areas by at least one discontinuous isolated line in x-axis; a plurality of parallel electrode pairs in y-axis, formed on the edges of both sides in y-axis direction of the conductive layer in series and with symmetry, connected to a voltage controlled unit, defining the plurality of the touch areas as a plurality of y-axis areas by at least one discontinuous isolated line in y-axis; and a plurality of series electrode chains, formed on the conductive layer, the two terminals of each of the plurality of series electrode chains are connected to either the two terminals of at least one parallel electrode pair in x-axis or the two terminals of at least one parallel electrode pair in y-axis and enclosed the internal contact area, each of the plurality of series electrode chains includes a plurality of electrodes which possess an internal part and forms a gap between the plurality of electrodes; wherein the voltage controlled unit provides a voltage to at least one parallel electrode pair in x-axis and at least one parallel electrode pair in y-axis, and the voltage is transmitted by connecting the series electrode chains to at least one detecting area in x-axis and at least one detecting area in y-axis, and touch detection is performed.

The detailed features and advantages of the disclosure will be described in detail in the following embodiments. Those skilled in the arts can easily understand and implement the content of the disclosure. Furthermore, the relative objectives and advantages of the disclosure are apparent to those skilled in the arts with reference to the content disclosed in the specification, claims, and drawings.

### BRIEF DESCRIPTION OF THE DRAWINGS

The disclosure will become more fully understood from the detailed description given herein below for illustration only, and thus are not limitative of the disclosure, wherein:

FIG. 1 is a schematic diagram of a five-wire touch panel 10 of the prior art;

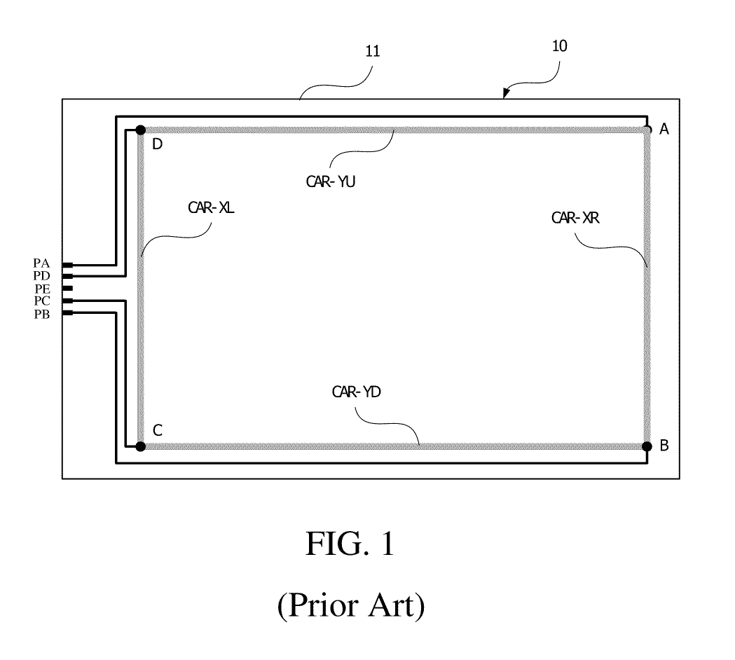

FIG. 2 is a schematic diagram of a controlled mode of detecting voltage in the y-axis of the touch panel of the prior art;

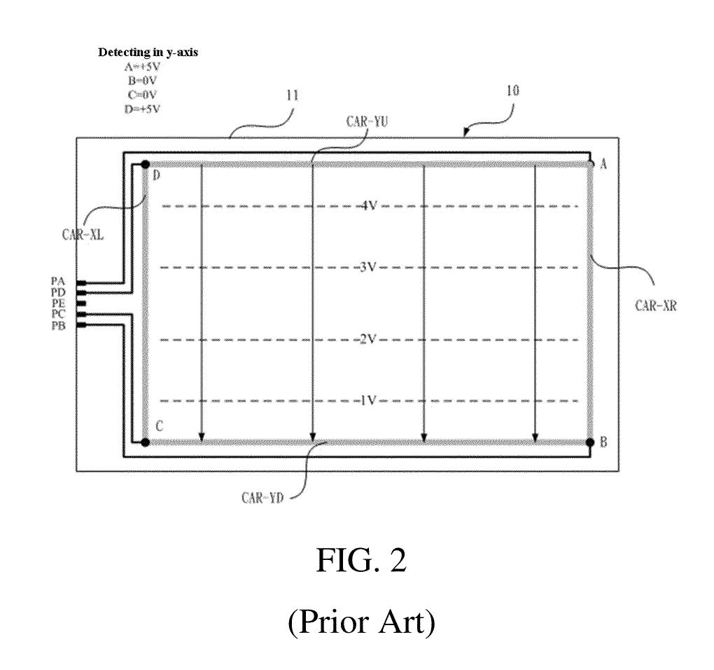

FIG. 3 is a schematic diagram of a controlled mode of detecting voltage in the x-axis of the touch panel of the prior art;

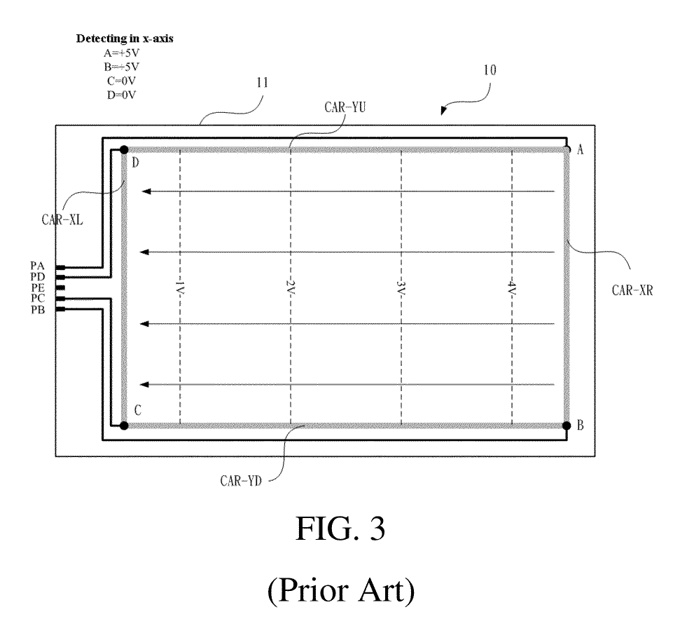

FIG. 4 is the schematic diagram of the first example of a touch panel with the matrix-type parallel electrode series 100 of the disclosure;

FIG. 5 is a schematic diagram of scanning the second axis in FIG. 4;

FIG. 6 is a schematic diagram of scanning the third axis in FIG. 4;

FIG. 7 is a schematic diagram of scanning the fifth axis in FIG. 4;

FIG. 8 is a schematic diagram of the first embodiment of a physical pattern of a touch panel with the matrix-type parallel electrode series 100 of the disclosure;

FIG. 9 is a partially magnified diagram of the embodiment in FIG. 8;

FIG. 10 is an etching diagram of a conductive layer of the embodiment in FIG. 8;

FIG. 11 is a schematic diagram of a pattern of a conductive frame of the embodiment in FIG. 8;

FIG. 12 is a schematic diagram of the second embodiment of a physical pattern of a touch panel with the matrix-type parallel electrode series 100 of the disclosure;

FIG. 13 is a partially magnified diagram of the embodiment in FIG. 12;

FIG. 14 is a schematic diagram of pattern of a conductive frame of the embodiment in FIG. 12;

FIG. 15 is a schematic diagram of the third embodiment of a physical pattern of a touch panel with the matrix-type parallel electrode series 100 of the disclosure;

FIG. 16 is a partially magnified diagram of the embodiment in FIG. 15;

FIG. 17 is a schematic diagram of a pattern of a conductive frame of the embodiment in FIG. 15;

FIG. 18 is the schematic diagram of the second example of a touch panel with the matrix-type parallel electrode series 200 of the disclosure;

FIG. 19 shows an etching diagram of a conductive layer of the embodiment in FIG. 18;

FIG. 20 is a schematic diagram of the first embodiment of a physical pattern of a touch panel with the matrix-type parallel electrode series 200 of the disclosure;

FIG. 21 is a partially magnified diagram of the embodiment in FIG. 20;

FIG. 22 is a schematic diagram of the second embodiment of a physical pattern of a touch panel with the matrix-type parallel electrode series 200 of the disclosure;

FIG. 23 is a partially magnified diagram of the embodiment in FIG. 22;

FIG. 24 is a schematic diagram of the first embodiment of a conductive layer isolated by the dash line of a touch panel with the matrix-type parallel electrode series of the disclosure;

FIG. 25 is a partially magnified diagram of touch block 302 in FIG. 24;

FIG. 26 is an etching diagram of a conductive layer of the embodiment in FIG. 24;

FIG. 27 is a schematic diagram of the second embodiment of a conductive layer isolated by the dash line of a touch panel with the matrix-type parallel electrode series of the disclosure;

FIG. 28 is an etching diagram of a conductive layer of the embodiment in FIG. 27;

FIG. 29 is a schematic diagram of the first embodiment of a detection flowchart of a touch panel with the matrix-type parallel electrode series of the disclosure;

FIG. 30 is a schematic diagram of the second embodiment of a detection flowchart of a touch panel with the matrix-type parallel electrode series of the disclosure; and

FIG. 31 is a schematic diagram of the second embodiment of a detection flowchart of a touch panel with the matrix-type parallel electrode series of the disclosure.

### DETAILED DESCRIPTION

Different from the conventional four corner electrodes, the disclosure designs multiple pairs of the symmetric parallel electrodes, forms the single point positioning in different areas by applying the scanning in a different time sequence, and then meets the goal of detecting multiple touch points. For example, the four touch points in four blocks are detected using the two parallel electrode pairs in x-axis and the two parallel electrode pairs in y-axis, the nine touch points in nine blocks are detected using the three parallel electrode pairs in x-axis and the three parallel electrode pairs in y-axis, and so on. That is, the MxN touch points in MxN blocks are detected using M parallel electrode pairs in x-axis and N parallel electrode pairs in y-axis where M, N are the integrals at least equal and larger than one.

The benefits of using the analog touch panel are skillful art, high yield, and low price. The high precision detection of multiple touch points can be realized by the current increased precision and the matrix-type parallel electrode series of the disclosure. This results in a higher price/performance ratio when compared to the touch panel adapting PCT for the detection of multiple touch points.

Moreover, the matrix-type parallel electrode structure of the disclosure can realize the capacitive-type touch detection simply by applying a conductive layer instead of two conductive layers, which can greatly reduce the cost.

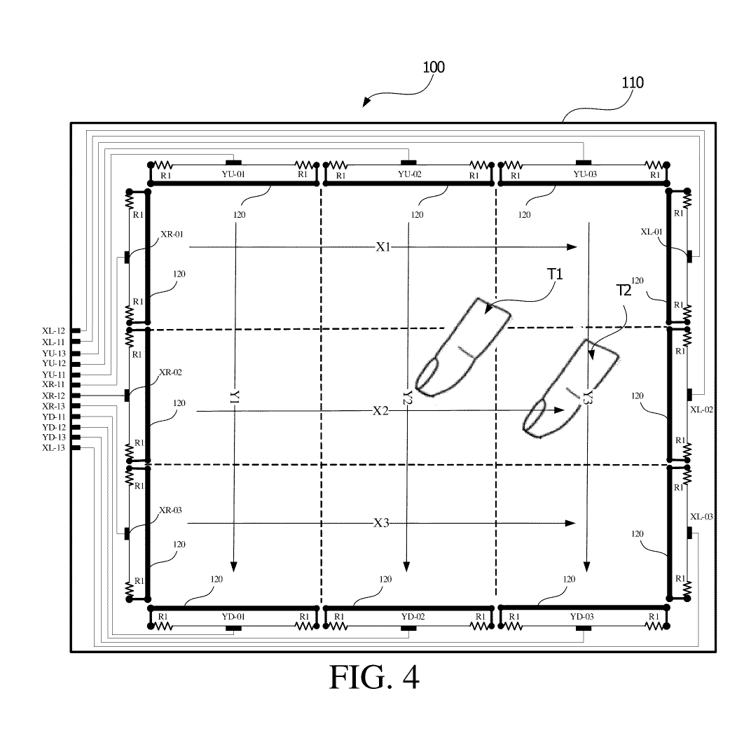

Please refer to FIG. 4, which is the schematic diagram of the first example of a touch panel with the matrix-type parallel electrode series 100 of the disclosure, which also shows the application of parallel electrode matrix of 3×3. It scans and derives precisely the touch results of the nine blocks as shown in FIG. 4. This will now be explained first. The parallel electrode matrix of MxN is fabricated using the same electrode structure mentioned in the disclosure. The embodiment in FIG. 4 is one of the structures mentioned above. Using the disclosing according the disclosure, the embodiment of different kinds of blocks of MxN matrix can be fabricated. This is described in detail in the following paragraphs.

Please refer to the touch panel 100 in FIG. 4, of which the substrate is formed by the conductive layer 110 (un-sketched). The three pairs of symmetric parallel electrodes in x-axis, XR-01/XL-01, XR-02/XL-02, XR-03/XL-03, and the three pairs of symmetric parallel electrode in y-axis, YU-01/YD-01, YU-02/YD-02, YU-03/YD-03 are formed on the four edges of the conductive layer 110. Moreover, every parallel electrode structure is the same as or similar to each other, which provides a uniform electrical field for the scanning block. The parallel electrode series of the disclosure can be applied to a resistive-type touch panel or the surface capacitive touch screen (SCT), which is in demand for forming an equal electrical field.

The two terminals of the three pairs of symmetric parallel electrode in y-axis, YU-01/YD-01, YU-02/YD-02, YU-03/YD-03 and the two terminals of the three pairs of symmetric parallel electrode in x-axis, XR-01/XL-01, XR-02/XL-02, XR-03/XL-03 connected to the resistor, R1, respectively. The resistor, R1, connected to the two terminals of each parallel electrode is connected to the series electrode chain 120, which is arranged to each parallel electrode. Using the external voltage controlled unit, the electrode plate YU-11, YD-11, YU-12, YD-12, YU-13, YD-13, XR-11, XL-11, XR-12, XL-12, XR-13, XL-13, and the conductive wire, the controlled voltage is transmitted to each parallel electrode, forming the control of output voltage, which results in the internal contact area of the conductive layer 110 becoming nine blocks as shown in FIG. 4 and forms the touch scanning detection mechanism.

The parallel electrodes and the conductor wires can be chosen from silver conductor wires or other metals, such as molybdenum/aluminum/molybdenum metal layers, chromium conductor wires, or other metals with better electric conductivity. Preferably, silver conductor wires fabricated by silver paste above 500° C. may be chosen, for the purpose of reducing frame-width by effectively narrowing the wires, resulting in low resistivity (low power consumption), and better linear support of the touched area edge.

Since the resistances of the silver conductor wires are identical to each other and close to zero, the voltage drops between the four electrode plates, YU-11, YD-11, YU-12, YD-12, YU-13, YD-13, XR-11, XL-11, XR-12, XL-12, XR-13, XL-13, and the parallel electrode, YU-01, YD-01, YU-02, YD-02, YU-03, YD-03, XR-01, XL-01, XR-02, XL-02, XR-03, XL-03, connected by using four silver conductor wires, are nearly zero. Furthermore, the voltage drops of the two terminals of the parallel electrodes, i.e. the parts connected to resistances, R1, are equivalent to the voltage provided by four electrode plates, YU-11, YD-11, YU-12, YD-12, YU-13, YD-13, XR-11, XL-11, XR-12, XL-12, XR-13, XL-13. This is because the parallel electrodes are fabricated from silver conductor wires. The voltage drops at the two terminals of the series electrode chain 120, are not ignored because of the resistance, R1. The range of the voltage drops depends on the total resistance value (effective resistance value), of resistance, R1, and the resistances of series electrode chain 120. That is, the value of resistance, R1, can be determined firstly, and designed in conformity with the demands of practical power consumption.

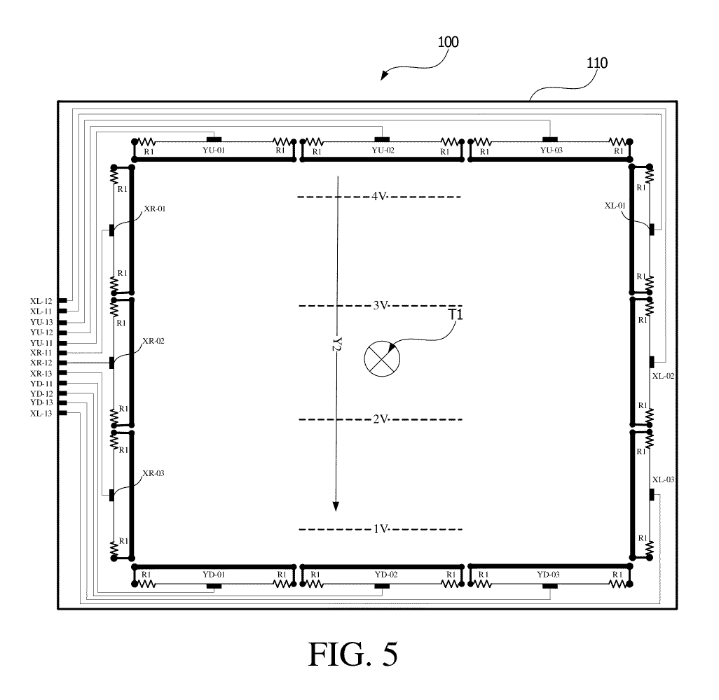

The detection of multiple touch points of the matrix-type parallel electrode series of the parallel electrodes according to the disclosure is interpreted in the following figures. For the purpose of this description, FIG. 5 to FIG. 7 uses T1 and T2 in FIG. 4 as examples. The variations of the voltage or the current happened by the touch in the directions of Y1, Y2, Y3, X1, X2, X3 are derived by the sequential scanning using the parallel electrode in x-axis and the parallel electrode in y-axis in every scanning period. Moreover, the precise position of touch point T1 can be derived by the touch points in x-axis and y-axis.

FIG. 5 is a schematic diagram of scanning the second axis in FIG. 4 which is to scan in the direction of Y2. Meanwhile, the parallel electrode YU-02/YD-02 provides the voltage of 5V and ground, respectively. The other parallel electrode is floatingly connected. The conductive layer 110 in the directions of Y1 and Y3 is not conductive. Therefore, the touch point T1 in the fifth block can be detected in the direction of Y2.

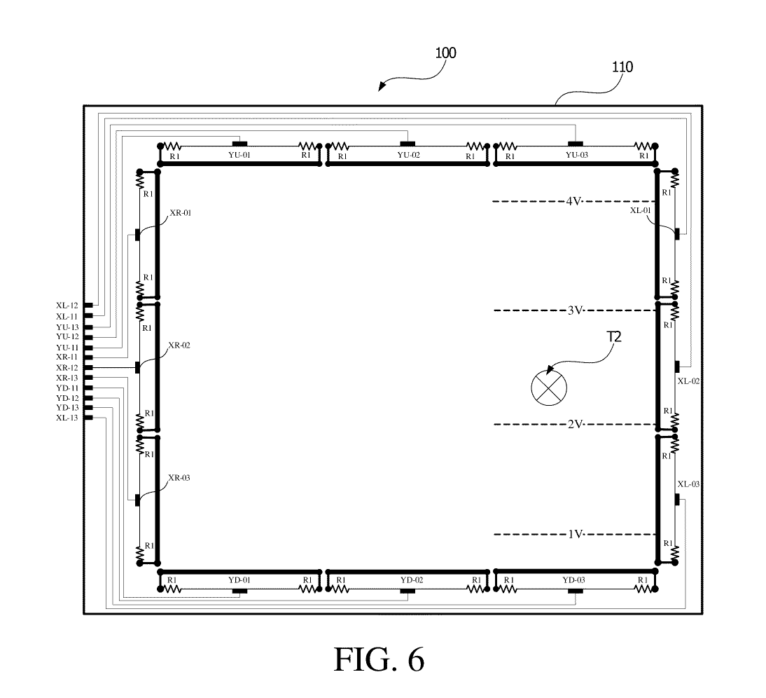

FIG. 6 is a schematic diagram of scanning the third axis in FIG. 4, which is to scan in the Y3 direction. Meanwhile, the parallel electrode YU-03/YD-03 provides the voltage of 5V and ground, respectively. The other parallel electrode is floating connected. The conductive layer 110 in the directions of Y1 and Y2 is not conducting. Therefore, the touch point T2 in the sixth block can be detected in the direction of Y3.

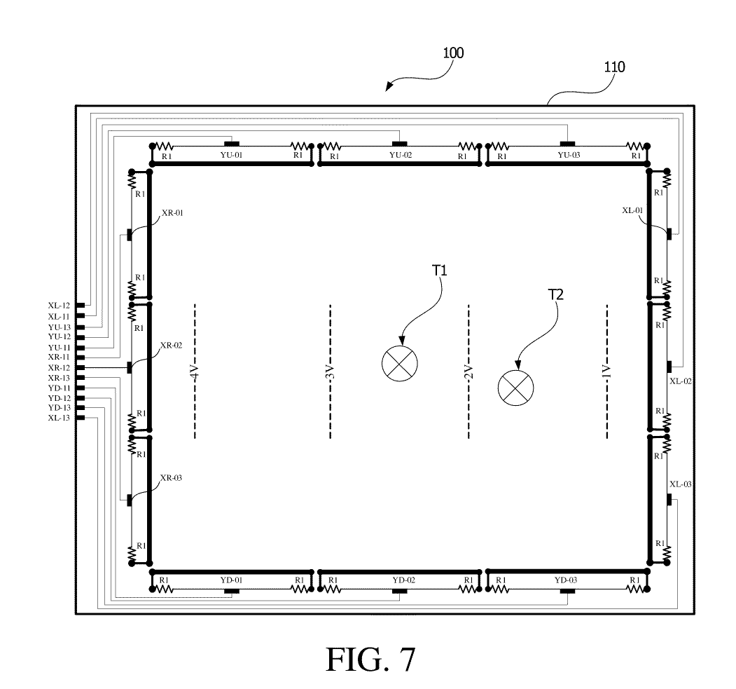

FIG. 7 is a schematic diagram of scanning the fifth axis in FIG. 4, which is to scan in the X2 direction, meanwhile, the parallel electrode XR-02/XL-02 provides the voltage of 5V and ground, respectively. The other parallel electrode is floating connected. The conductive layer 110 in the directions of X1 and X3 is not conductive. Therefore, the touch point T2 in the sixth block and T1 in the fifth block can be detected in the direction of X2. Thus, the scanning result in FIG. 7 is the combination of the two results since only one point can be scanned in every block. Therefore, to derive the real position, the calculated described previously is required.

After the scanning in a period, the coordinates of the touch points in the fifth block and sixth block can be derived by the scanning in FIG. 5 and FIG. 7, and the two touch points and their coordinates can be determinate, since every parallel electrode and the electrodes connected with the chain of series are similar or the same in structure. The parallel electrodes series formed by nine parallel electrodes and the series electrode chain is shown in the embodiment in FIG. 4. Therefore, the detection result in the same touch position can be derived in one scanning period with the same voltage supplied. In this case, the working voltage supply is between 1.5-15V.

The matrix-type parallel electrode series of the disclosure can meet the goal of uniform electrical field by adopting the fabrication of different kinds of series electrode chain. The uniform electrical field makes the precision of touch detection higher, which improves user satisfaction. Therefore, many companies expend considerable effort to improve precision. The precise of the conventional analog touch screen is already 1%, however, it cannot proceed the multiple detection points. The different kinds of scanning structure can be designed using the matrix-type parallel electrode series of the disclosure with single structure, as the MxN mentioned above.

Since the precise is affected by the structure of the series electrode, the goal of multiple point detection of the disclosure can be meet by adapting different kinds of structure of the series electrode.

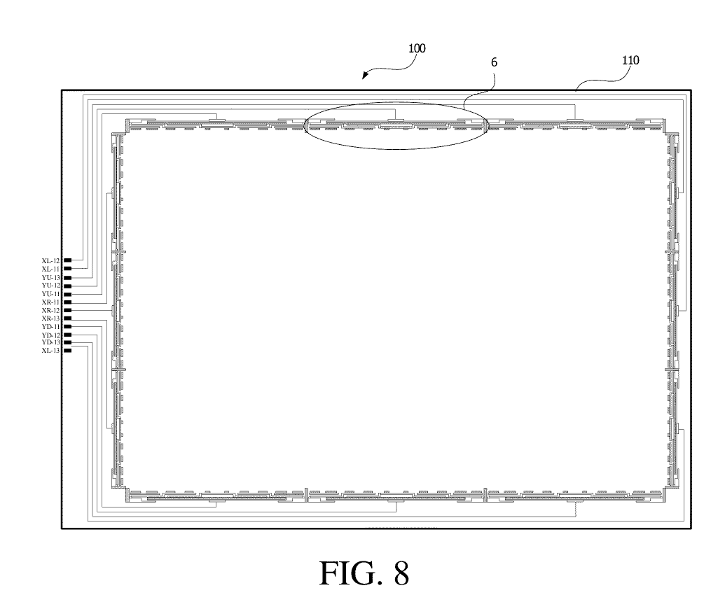

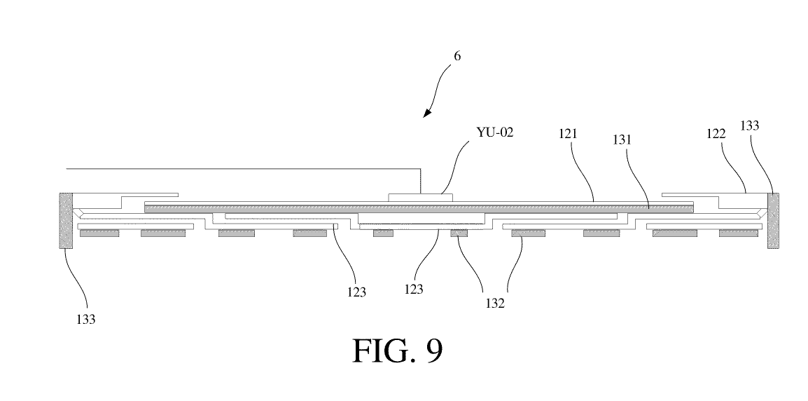

Please refer to FIG. 8, which is the first embodiment of a physical pattern of a touch panel with the matrix-type parallel electrode series of the disclosure. It describes the physical structure of the series electrode chain 120 and the R1. The series electrode chain connected to every parallel electrode is connected using the corner electrodes of the two terminals and the corner resistance. In the embodiment, every series electrode chain is fabricated by the Z-shaped electrode. Moreover, the discontinuous resistance chain is further fabricated in the part of the Z-shaped electrode close to the internal contact area of the conductive layer 110. Furthermore, there are insulated segments between the parallel electrode and the series electrode chain. The gaps between every parallel electrode series are also insulated by the insulated segments. For details of the parallel electrode series 6, please refer to FIG. 9.

The parallel electrode series 6 in FIG. 9 is the connector between the parallel electrode YU-02 and its extender segment 121. Since each parallel electrode series is the same or similar in structure, only one parallel electrode series is provided here for the explanation. At the two sides of the structure, the structure insulated segment 133 makes the parallel electrode series 6 and the other parallel electrode series insulated, which prevents the voltage fed to the adjacent parallel electrode series while the supply voltage in scanning. The structure insulated segment 133 makes the voltage of the parallel electrode series 6 produce an electrical field which is symmetrical to the parallel electrode YD-02, and form a separated electrical field. At the bottom of the parallel electrode YD-02, there is an electrode insulated segment 131 which makes the parallel electrode YD-02 and the series electrode 123 of the series electrode chain isolated, and makes the parallel electrode YD-02 transmits the voltage to the series electrode chain from the two terminals instead of from center of the parallel electrode. There is a corner electrode 122 connected to each terminal of the series electrode chain respectively, which forms a gap between the parallel electrodes YD-02. The gap is a part of the conductive layer 110, which forms the resistance R1.

After the voltage is transmitted by the Z-shaped electrode 123 of the series electrode chain transmitted to the chain of series resistances formed by the series electrode chain, the drop voltage is carried out. Therefore, compensation of the voltage of the discontinuous resistances is necessary to make the output voltage of the series electrode chain more uniform, wherein the discontinuous resistances are formed by the gap forming by the conductive layer 110 and discontinuous insulated segment 132. Thus, the final electrical field produced on the internal contact area of the conductive layer 110 becomes more uniform.

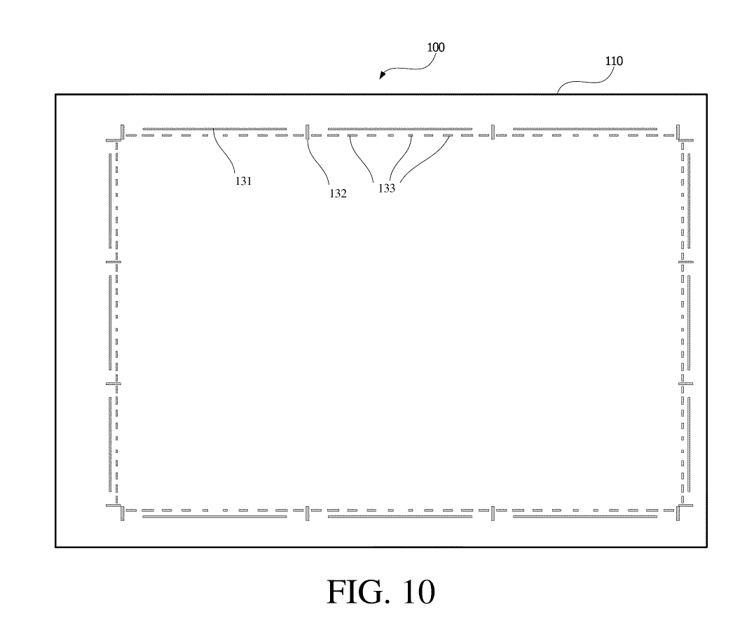

The electrode insulated segment 131, the discontinuous insulated segment 132 and the structure insulated segment 133 can form gaps on the conductive layer 110 by firstly using a method such as etching or laser, and finally filling the insulation. The physical pattern is shown in FIG. 10. Each parallel electrode series is similar or the same in structure. Thus, the electrode insulated segment 131, the discontinuous insulated segment 132 and the structure insulated segment 133 are arranged symmetrically according to the nine blocks in FIG. 10.

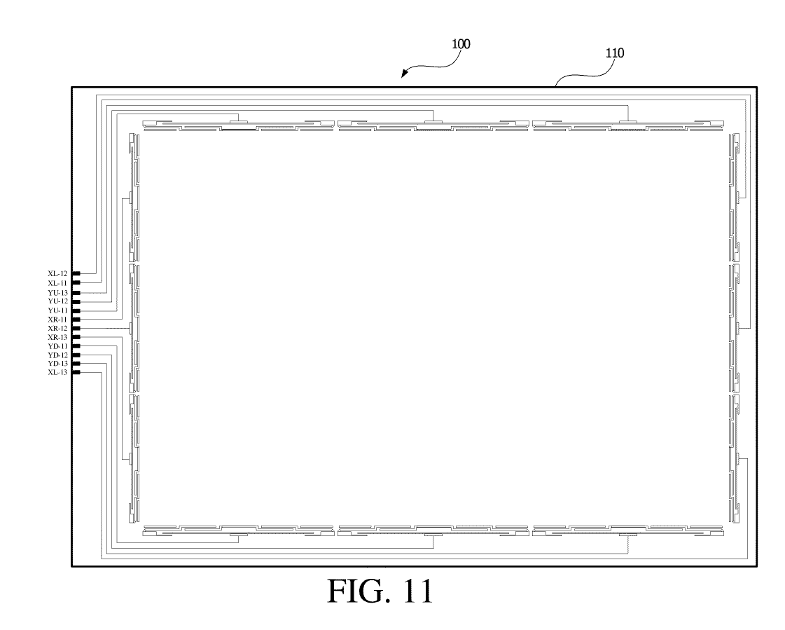

In manufacturing process, the insulated segment and the conductive frame are formed on the conductive layer 110. The conductive frame includes all kinds of electrodes described above. Please refer to FIG. 11, the parallel electrode series of each block is fabricated the same as the parallel electrode YU-02, the extender segment 121 of the parallel electrode YU-02 of the parallel electrode series, the corner electrode 122 and the series electrode chain 123 according to FIG. 9. The electrode frame fabricated in FIG. 9 and further formed as the insulated segment on the conductive layer 110 in FIG. 10 is formed as the pattern in FIG. 8.

The description of the first embodiment of the structure of the series electrode chain of the disclosure is shown from FIG. 8 to FIG. 11. It describes the series electrode chain and how the discontinuous segment formed on the conductive layer 110 is applied to form the discontinuous resistance segment, and to make the voltage transmitted by the parallel electrode form uniformly on the internal contact area of the conductive layer. Thus, the uniform electrical field of different blocks is produced according to the sequential timing controlling and voltage providing to the different blocks under the control of the external voltage controlled unit. The detection of the touch behavior in different blocks is performed.

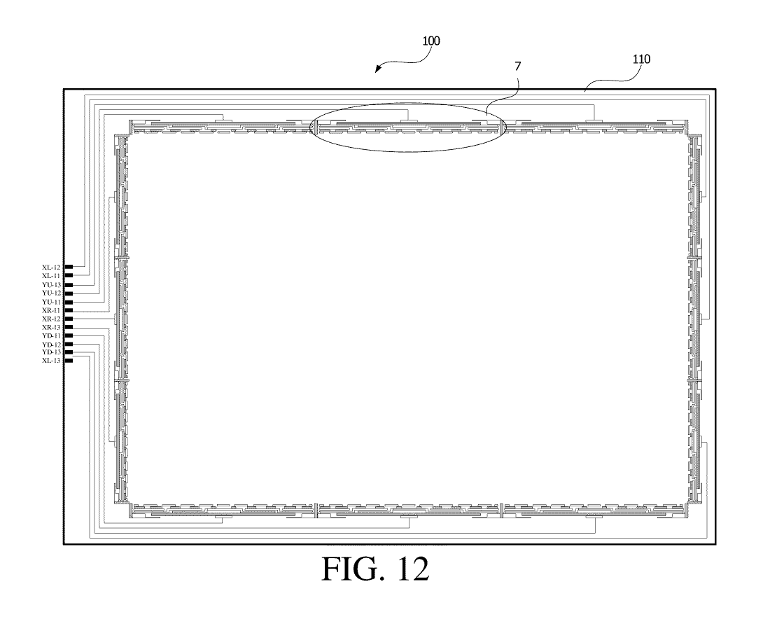

In the following paragraphs, the description of the first embodiment of the structure of the series electrode chain of the disclosure is shown from FIG. 12 to FIG. 14. It describes the chain of the first equalized electrode fabricated close to the discontinuous segment and the internal contact area of the conducting 110. The chain of the first equalized electrode is formed by the gap of the first equalized electrode 124 Please refer to FIG. 12. Similarly, a pair of the chain of the first equalized electrode which includes a plurality of the first equalized electrode 124 is fabricated within every parallel electrode series. The chain of the first equalized electrode forms an output of equalized electrical field which is formed by the discontinuous resistance chain and makes the electrical field formed by the parallel electrode series form a good distribution of electrical field at the edge of the chain of the first equalized electrode, decreasing the ripple effect considerably.

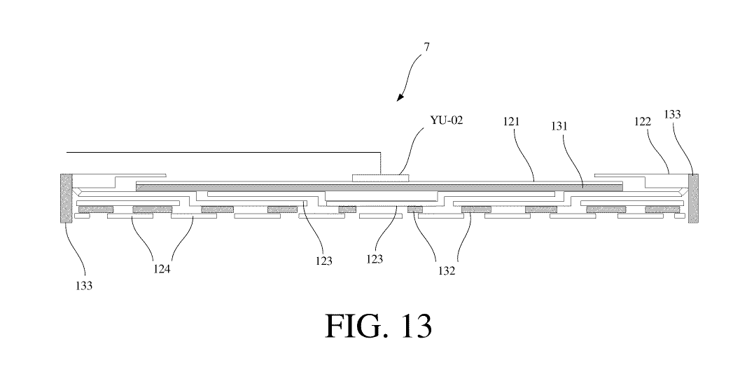

Throughout the following paragraphs, please refer to FIG. 13, which shows the magnified diagram of the parallel electrode series 7. Since every parallel electrode series is the same or similar in structure, only one parallel electrode series is provided here for the purpose of explanation. The difference between parallel electrode series 7 and the parallel electrode series 6 in FIG. 9 is the chain of the first equalized electrode formed by the first equalized electrode 124. The chain of the first equalized electrode is fabricated at the edge of the discontinuous resistance chain and pasted tightly on the internal contact area of the conductive layer 110. Since the chain of the first equalized electrode is distributed uniformly on the edge of the discontinuous resistance chain, the compensated voltage transmitted from the discontinuous resistance chain can be transmitted uniformly to from the chain of the first equalized electrode to the conductive layer 110 and formed as a further uniform electrical field. That is, the linearity of the edge electrical field of the conductive layer 110 increases after the chain of the first equalized electrode is applied, which reduces the ripple effect even further.

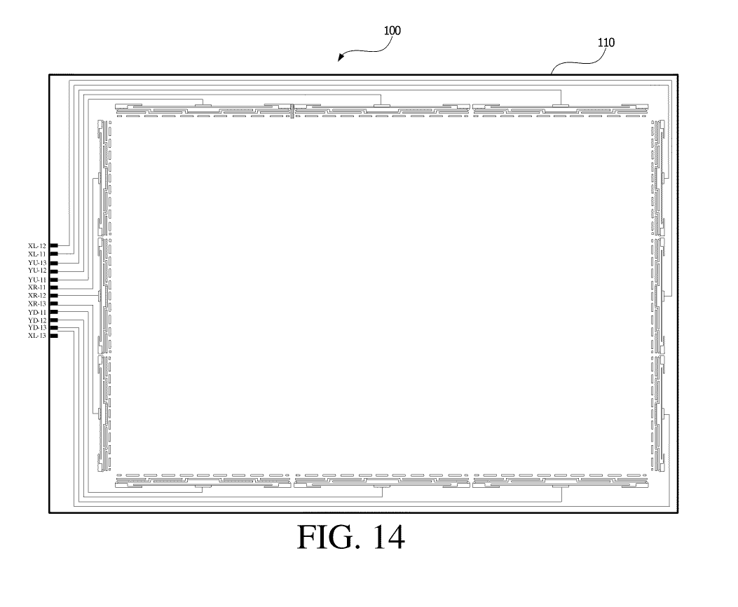

Throughout the following paragraphs, please refer to FIG. 14, which is a schematic diagram of pattern of a conductive frame of the second embodiment in FIG. 12 of the disclosure. When compared to FIG. 11, it is clearly discovered that the electrode frame in FIG. 14 increases the chain of the first equalized electrode, and the others are the same. Moreover, the design of the pattern of the insulated segment can adopted the design in FIG. 10.

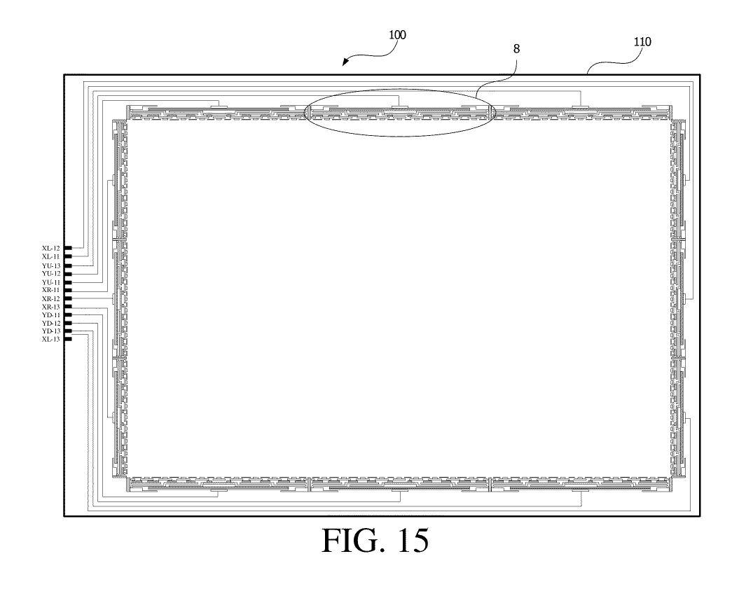

In the following paragraphs, the description of the three embodiments of the structure of the series electrode chain of the disclosure is shown from FIG. 15 to FIG. 17. It describes the chain of the second equalized electrode as fabricated close to the discontinuous segment and the internal contact area of the conducting 110. The chain of the first equalized electrode is formed by the gap of the second equalized electrode 126. Please refer to FIG. 15. Similarly, a pair of the chain of the first equalized electrode which includes a plurality of the second equalized electrode 126 is fabricated within every parallel electrode series. The chain of the first equalized electrode forms an output of equalized electrical field which is formed by the discontinuous resistance chain, and makes the electrical field formed by the parallel electrode series form a good distribution of electrical field at the edge of the chain of the first equalized electrode, which reduces the ripple effect considerably.

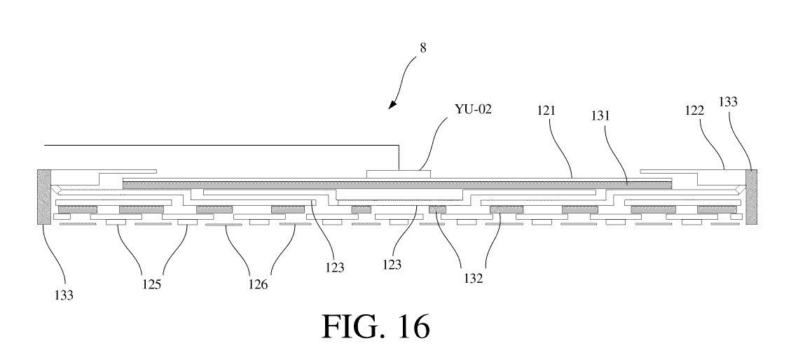

Please refer to FIG. 16, which is the magnified diagram of the parallel electrode series 8. Since each parallel electrode series is the same or similar with each other in structure, here only provides one parallel electrode series as explanation. The difference between parallel electrode series 8 and the parallel electrode series 7 in FIG. 13 is that, the first equalized electrode 124 in FIG. 13 is linear; the first equalized electrode 125 in FIG. 16 is T-shaped (a part of a horizontal stick and a part of a perpendicular stick). Moreover, the chain of the second equalized electrode is formed by the plurality of the second equalized electrode 126 in FIG. 16. The chain of the second equalized electrode is fabricated at the edge of the discontinuous resistance chain and pasted tightly on the internal contact area of the conductive layer 110. Since the chain of the first equalized electrode is distributed uniformly on the edge of the discontinuous resistance chain, the compensated voltage transmitted from the discontinuous resistance chain can be transmitted uniformly to from the chain of the first equalized electrode to the conductive layer 110 and formed as a further uniform electrical field. That is, the linearity of the edge electrical field of the conductive layer 110 increases after applying the chain of the first equalized electrode, which reduces the ripple effect even further. The uniformity of the electrical field is increased by the arrangement of the chain of the second equalized electrode.

The second equalized electrode 126 seen in FIG. 16 is linear. The bottom of the perpendicular stick of the first equalized electrode 125 and the second equalized electrode 126 is arranged in parallel. Therefore the output of the first equalized electrode 125 and the output of the second equalized electrode 126 is the same, resulting in uniform voltage distribution in the contact area of the conductive layer 110. It is preferable that the length of the T-shaped bottom (the part of the perpendicular stick), of the first equalized electrode 125 is equal to the length of the second equalized electrode 126. The interval formed by the edge of the T-shaped bottom (the part of the perpendicular stick), of the first equalized electrode 125 and the edge of the second equalized electrode 126 is in proportion to the length of the second equalized electrode 126. The preferable ratio is 2:3, and it can also be the ratio of 1/5, 1/4, 1/3, 1/2, 2/5, 2/7, 3/5, 3/7, 4/5 . . . etc, the best uniformity of the electrical field can be determined by actual testing.

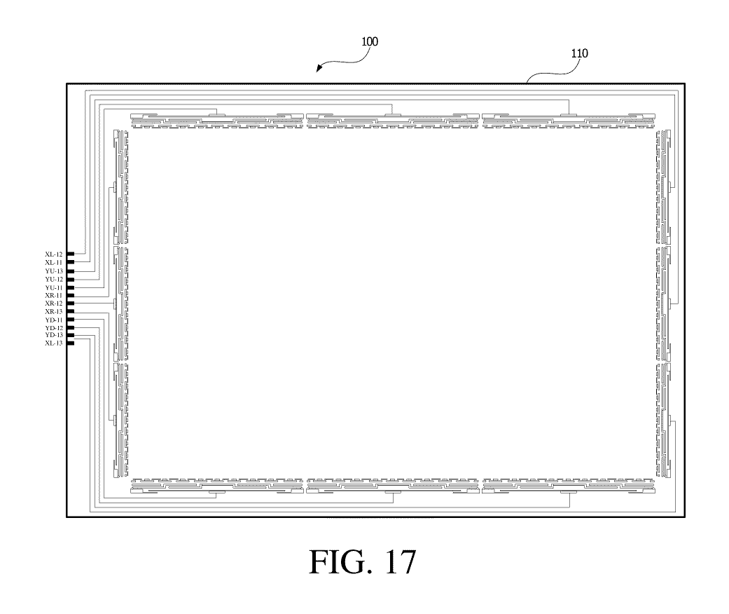

In the following paragraphs, FIG. 17 is used to show a schematic diagram of pattern of conductive frame of the first embodiment in FIG. 15 of the disclosure. When compared to FIG. 14, it is clearly discovered that electrode frame in FIG. 17 increases the chain of the second equalized electrode, and the others are the same. Moreover, the design of the pattern of the insulated segment can adopt the design in FIG. 10.

The first embodiment of FIG. 8 to FIG. 11, the second embodiment of FIG. 12 to FIG. 14, and the third embodiment of FIG. 15 to FIG. 17 use the design of the discontinuous resistance chain. From FIG. 9, FIG. 13, and FIG. 16, it is clearly observed that there is a part of the discontinuous resistances on the internal part of every Z-shaped series electrode 123; the centre of the perpendicular part of the Z-shaped series electrode corresponds to a part of the discontinuous resistances. Since the discontinuous resistance chain provides the different resistances for the voltage output of the Z-shaped electrode as the voltage compensation, the output voltage of every Z-shaped electrode transmitted through the discontinuous resistance segment is the same. The uniform distribution of the electrical field at the edge can be derived by the equalization of the chain of the first equalized electrode and the second equalized electrode, which reduces the ripple effect considerably.

The length of the discontinuous resistances is realized by the discontinuous resistances segment 132. The length can be calculated by many kinds of methods. In the following paragraphs, the disclosure uses an example for the purpose of description. The length of the discontinuous resistances is calculated by the equation of Y=aX²+b, described as followings:

1. X is the Z-shaped electrodes counted from the corner electrodes. For example, there are five Z-shaped electrodes, X1=1, X2=2, X3=3, X4=4, X5=5 as counted from the corner electrodes 411.

2. “b” is the default value derived from the experiment and statistics, the preferred value is between 0.3 to 2.0 mm.

3. “a” is calculated from Ymax, and its magnitude is derived from the length of center electrode 429 at the top in FIG. 6. The length of the center electrode is depending on the touch panel size and amount of the series electrode chain. The preferable value of Ymax subtracts 0.1 mm from both sides of the electrode length.

4. Via Ymax, b and X, the “a” value is derived.

Thus the length of Yₙ₋₁ is calculated by Yₙ₋₁=a(n−1)²+b. The length of Yₙ, is calculated by Yₙ=a(n)²+b. The length between Y_{n-0.5} and Yₙ₋₁ is calculated by means of I.X=(Xₙ₋₁+Xₙ)/2, then substituted into the equation II. Y=(Yₙ₋₁+Yₙ)/2. In practical terms, the first equation, I, is preferable.

The preferred position of the discontinuous resistances is determined by the perpendicular part center of the Z-shaped electrodes and the internal part of the center (the center of two perpendicular centers). The centre of the first equalized electrode corresponds to the centre of the discontinuous resistances. Naturally, minor production errors in manufacturing, or an off center arrangement in design, are also provided in the disclosure, which can still meet the goal of the disclosure.

Moreover, in practical terms, the discontinuous resistances can also be arranged by means of the internal part of the Z-shaped electrodes. In the other words, the disclosure arranges the discontinuous resistances between every electrode of the series electrode chain. In addition, as least one of the discontinuous resistances can also be arranged in the internal part of every electrode. At least one of the first equalized electrodes can be arranged in each one of the discontinuous electrodes. At least one of the second equalized electrodes can be arranged between the first equalized electrodes. That is, the number of discontinuous resistances, the first equalized electrodes and the second equalized electrodes dependents on the electrical field distribution requirement, as well as the considerations of cost and the precision in the manufacturing process.

If the internal part of electrodes of every series electrode is designed by using the plurality of discontinuous resistances, that is arranging the plurality of discontinuous resistances at the perpendicular centre on the Z-shaped electrodes (it can also be the internal part of an electrode between electrodes if the other electrode structure is adopted), then the length calculation of the discontinuous resistances located between the electrodes can also be derived by means of the two kinds of calculation mentioned above. For example, the preferred method is to arrange the discontinuous resistances with the same distance to the adjacent electrodes by arranging two discontinuous resistances in the internal part of Z-shaped electrodes. If the length is between Yₙ₋₁ and Yₙ, such as, Y_{n-0.67} and Y_{n-0.33}, then they are either determined as Y_{n-0.67}=a(n−0.67)²+b and Y_{n-0.33}=a(n−0.33)²+b or Y_{n-0.67}=(Yₙ₋₁*2+Yₙ*1)/3 Y_{n-0.33}=(Yₙ₋₁*1+Yₙ*2)/3 pwhere the former is the preferable.

The discontinuous resistances derived using different methods can also be applied to the disclosure. The uniform voltage distribution is formed using the first equalized electrode, and the arrangement of the first equalized electrode and the second equalized electrode. The use of Z-shaped electrodes is an embodiment of the disclosure. The shapes of different series electrode chain can also be the embodiment in the disclosure. Since the principle is the same, no more explanation is necessary in the following paragraphs.

The chain of the first equalized electrode, the chain of the second equalized electrode, the corner electrodes, the series electrode chain, the parallel electrode, conductive wire and the electrode plate . . . etc. are fabricated using screen printing procedure and selecting from a kind of environmental and unleaded silver paste at a high temperature. After fusing the silver on the conductive layer 300 with a temperature above 500° C., the conducting interface resistance is quite small (can be treated as zero). It possesses the characteristics of high environmental temperature tolerance. The chemical tolerance is increased after the crystallization of the silver conductive wires and the conductive layer 300 in high temperature. Also, the silver conductive wires can be replaced by the groups of molybdenum/aluminum/molybdenum metal layers and chromium conductive wires.

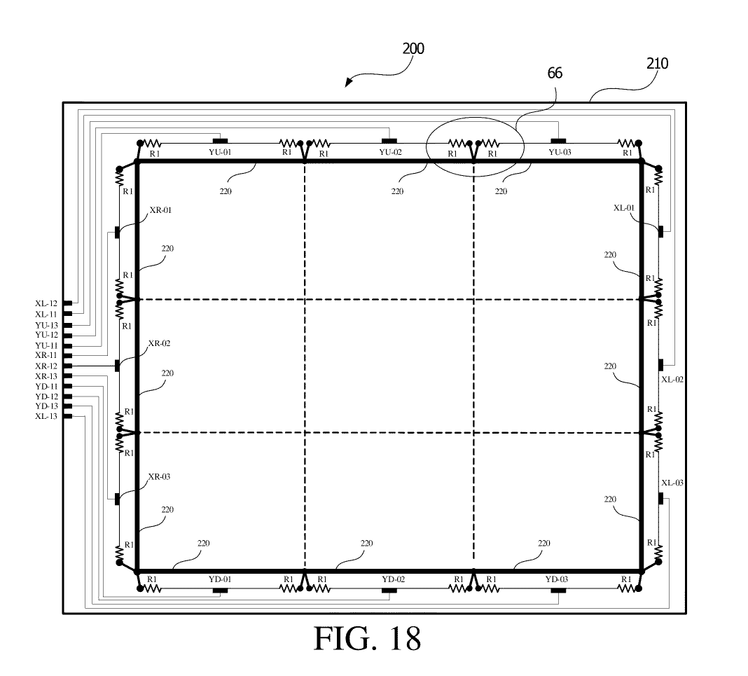

In the following, please refer to FIG. 18, which is the schematic diagram of the second example of a touch panel with the matrix-type parallel electrode series 200 of the disclosure, which is also the application of parallel electrode matrix of 3×3. Compared to the first example in FIG. 4, it is easy to discover that every parallel electrode series 220 is formed on the conductive layer 210 and connected to each other in the second example in FIG. 18. Since the others are the same, no more explanation is necessary in the following paragraphs.

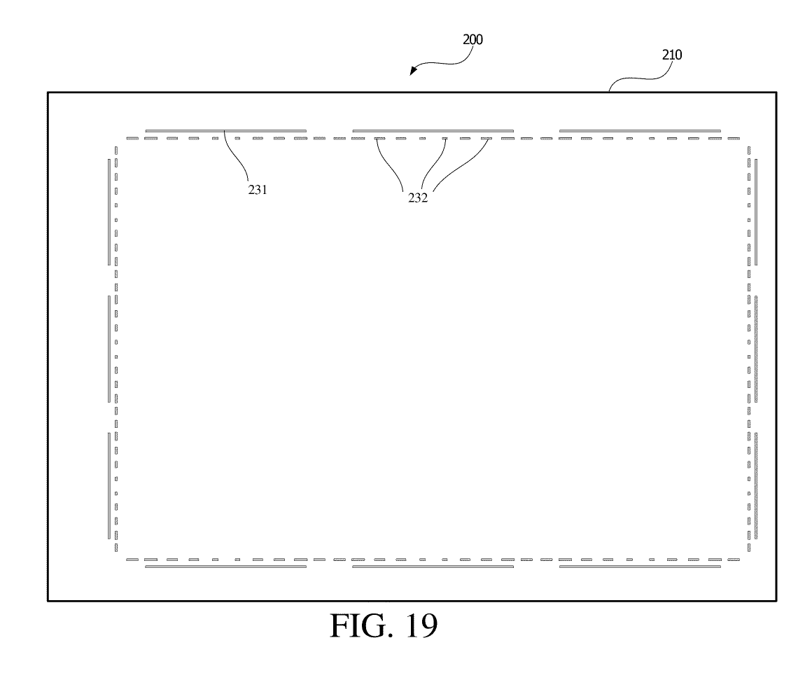

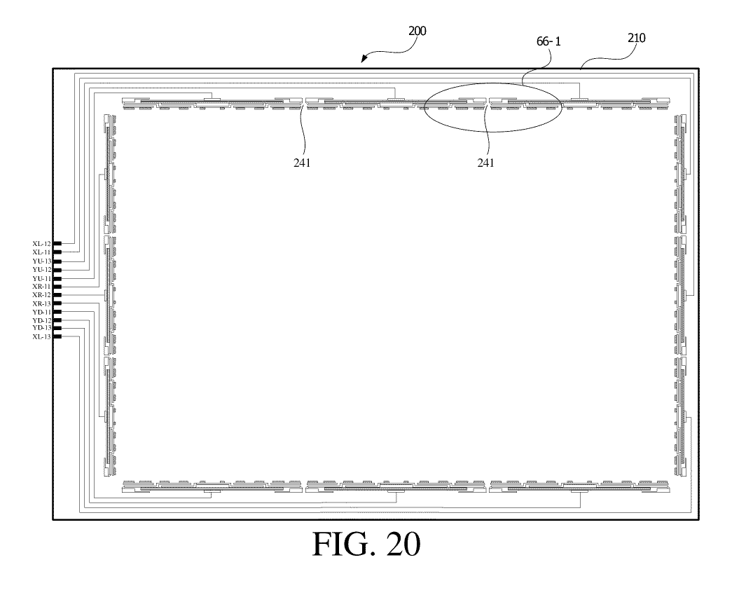

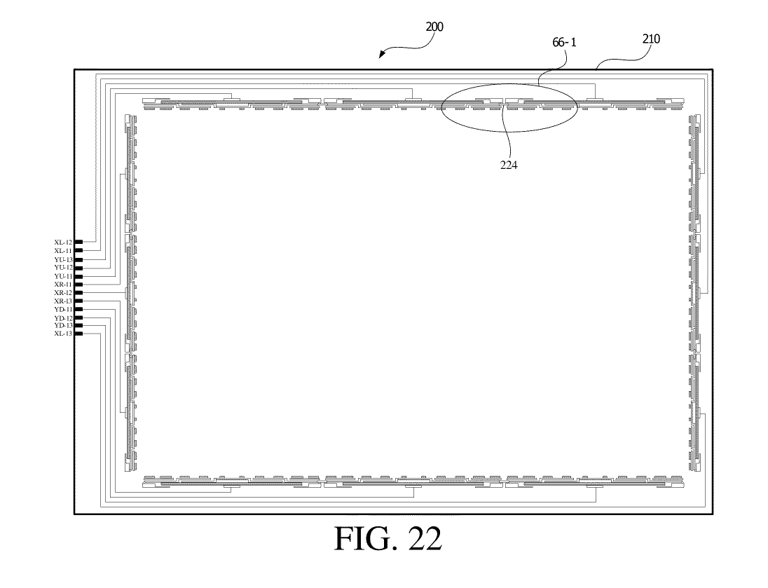

In the first example in FIG. 4, the series electrode chain 120 is isolated by the insulated segment 123 on the conductive layer 110, and realized by the pattern in FIG. 10. In the second example in FIG. 8, since the structure insulated segment is not necessary, thus, the pattern on formed the insulated segment can be realized by the pattern in FIG. 19.

Whereas, there are two kinds of connected method for the parallel electrode series 220, the first one is applying the conductive layer 210 directly; the second is applying the process of electrode to fabricate the connected bridge for the connection. Please refer to FIG. 20 and FIG. 22 for the description of these two methods.

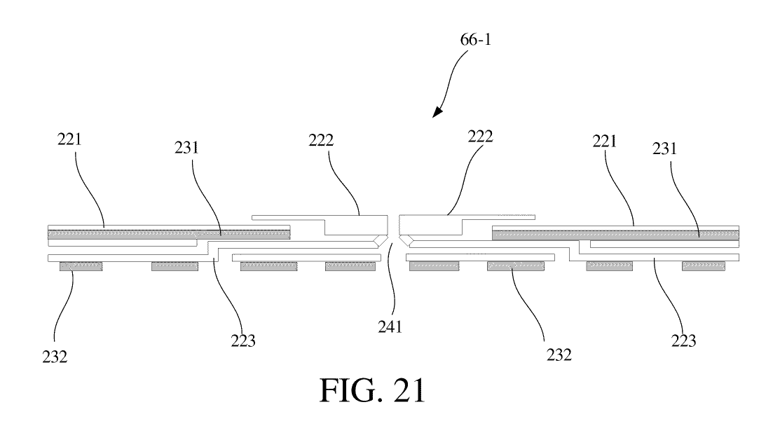

Please refer to FIG. 20, which is a schematic diagram of the first embodiment of the connecting method of parallel electrode series 220 of the disclosure. Compared to FIG. 8, it is easy to discover that there is no structure insulated segment. Moreover, there is a gap 241 formed on the conductive layer 210, which formed a resistance R2, connected to the parallel electrode series 220. The boundary 66-1 is magnified and shown in FIG. 21.

Please refer to FIG. 21, which is that the insulated segment only includes the electrode insulated segment 231 and the discontinuous insulated segment 232. Whereas the conductive frame also includes the parallel electrode YD-02, the extender segment 221 of the parallel electrode YD-02 of the parallel electrode series, the corner electrode 222 and the series electrode chain 223. The gap between two adjacent corner electrodes 222 is separated by the gap 241 which formed the resistance R2.

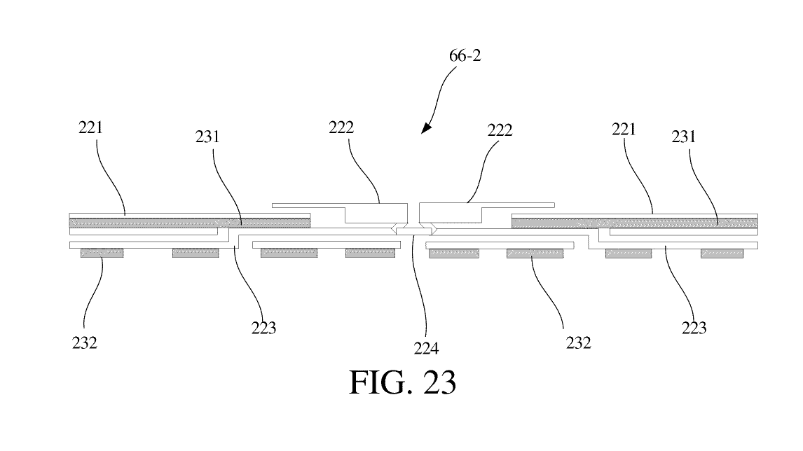

Please refer to FIG. 22, which is a schematic diagram of the second embodiment of the connecting method of parallel electrode series 220 of the disclosure. Comparing to FIG. 8, it is easy to discover that there is no structure insulated segment. Moreover, the conducting bridge 224 and the other conductive frame are formed on the conductive layer 210 together, and connect to the parallel electrode series 220. The boundary 66-2 is magnified and shown in FIG. 23.

Please refer to FIG. 23, which is that the insulated segment only includes the electrode insulated segment 231 and the discontinuous insulated segment 232. Whereas the conductive frame also includes the parallel electrode YD-02, the extender segment 221 of the parallel electrode YD-02 of the parallel electrode series, the corner electrodes 222, the series electrode chain 223 and the conducting bridge 224 which is connected to the two adjacent corner electrodes 222.

Except for the structure of the electrode frame in FIG. 20 and FIG. 22, the second embodiment of the disclosure in FIG. 18 can also adopt the structure of the electrode frame in FIG. 13 and FIG. 16. Since the difference in the structure is that whether the parallel electrode series is connected or not, no more explanation is necessary in the following paragraphs.

The disclosure provides three kinds of the connecting of the parallel electrode series: isolated type (FIG. 4), resistance connected type and the short type (two embodiments in FIG. 18), which can realize the purpose of multiple touch point detection and achieve the goal of the touch panel with the matrix-type parallel electrode series of the disclosure. The selection of the connecting type is depending on the pleasure of the designer, the size of the touch panel and the price/performance ratio.

No matter what the embodiment in FIG. 8, FIG. 12, FIG. 20 and FIG. 22, the error detection probably occurred due to the touch point on the different parallel electrode at the edge while performing the touch scanning on the parallel electrode in x-axis or y-axis. Thus, the disclosure further provides the precaution mechanism for the error detecting. The precaution mechanism is applying the discontinuous isolated line in x-axis and the discontinuous isolated line in y-axis to form the multiple isolated blocks to isolate the blocks in x-axis and the blocks in y-axis which correspond to the parallel electrode in x-axis and to the parallel electrode in y-axis, respectively and achieve the isolation without blocking the electrical field.

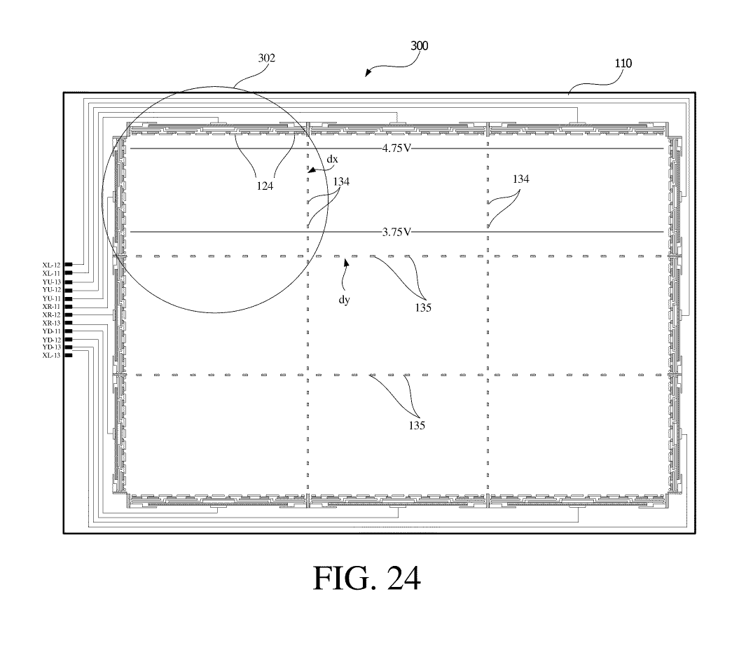

Please refer to FIG. 24, which is a schematic diagram of the first embodiment adopting the isolated dash line on the conductive layer of the touch panel with the matrix-type parallel electrode series 300 of the disclosure. FIG. 12 is the contrast in the design. Comparing to FIG. 12 and FIG. 24, it is easy to discover that the internal contact area of the conductive layer 210 is divided into a 3×3 pattern, that is, nine blocks, using the discontinuous isolated line in x-axis 134 and the discontinuous isolated line in y-axis 135 formed on the conductive layer 210. A touch point can be detected by each block, that is, there are nine touch points detected. If there is more touch points needed to be detected, the matrix can be further designed with a higher density of blocks, such 8×8 or 16×16.

The ghost shadow of the projective capacitive touch screen (PCT) would not occur in the touch panel with the matrix-type parallel electrode series of the disclosure.

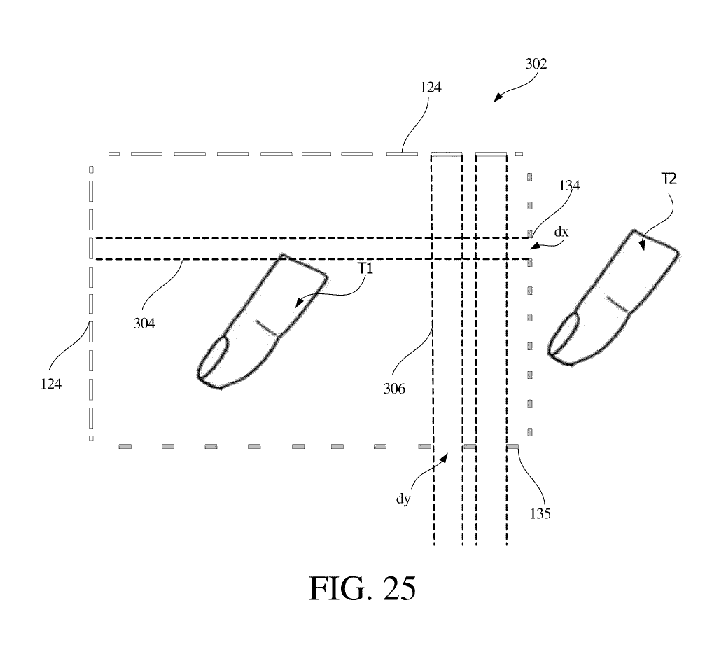

The design of the discontinuous isolated line in x-axis 134 and the discontinuous isolated line in y-axis 135 is the same as formatting of the discontinuous resistance segment. Thus, the precaution mechanism for the error detecting can be made more effectively without any increased cost in the production. The position is formed by the symmetrical series electrode chain, that is, the conducting part is centrally faced to the electrode of series electrode chain to form a good electrical field of the line type. The preferred embodiment is shown FIG. 25.

FIG. 25 is the partially magnified diagram of touch block 302 in FIG. 24. From FIG. 25, it is clear that the position of the touch point T1 is detected on the touch block 302 and the touch point T2 is detected at the right side of the touch block 302. Since the design of the discontinuous isolated line in x-axis 134 is discontinuous, the electrical field still can pass within the interval dx of the discontinuous isolated line in x-axis 134 and the interval dy of the discontinuous isolated line in y-axis 135. For example, in FIG. 25, the touch point T2 is detected out of the right side of the touch block 302. While the parallel electrode in x-axis on the touch block 302 is detected by scanning, the touch point T2 would not make the current of the touch block 302 flow away because of the isolation of the discontinuous isolated line in x-axis 134. That is, the effect can be ignored.

The design of the discontinuous isolated line in x-axis 134 and the discontinuous isolated line in y-axis 135 is symmetrical to the series electrode chain. That is, the electrode is the closest to the internal contact area. Take the embodiment in FIG. 24 as the example, the electrode is the closest to the internal contact area, which is the first equalized electrode 124. Regardless of the discontinuous isolated line in x-axis 134 and the discontinuous isolated line in y-axis 135, both of them are formed symmetrically to the first equalized electrode 124 In the other words, since the x-axis discontinuous isolated line 134 and the y-axis discontinuous isolated line 135 are etched insulated segments. Therefore, the length of the nearby interval dx and dy is centrally and in parallel faced to the first equalized electrode 124, where the preferred length is equal to the length of the first equalized electrode 124.

Similarly, if the embodiment in FIG. 8 is taken as an example, the preferred length of the interval dx and dy is equal to the discontinuous resistance segment while the discontinuous isolated line in x-axis and the discontinuous isolated line in y-axis faces to the discontinuous resistance segment centrally.

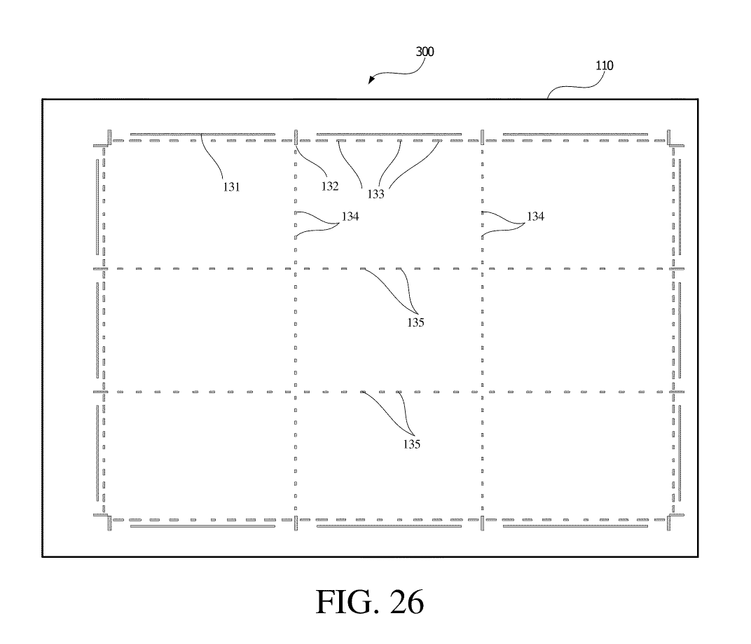

Please refer to FIG. 26, which is the etched diagram of the conductive layer of the embodiment in FIG. 24. It describes that the electrode insulated segment 131, the discontinuous resistance segment 132, the structure insulated segment 133, the discontinuous isolated line in x-axis 134 and the discontinuous isolated line in y-axis 135 can be formed simultaneously within the same process.

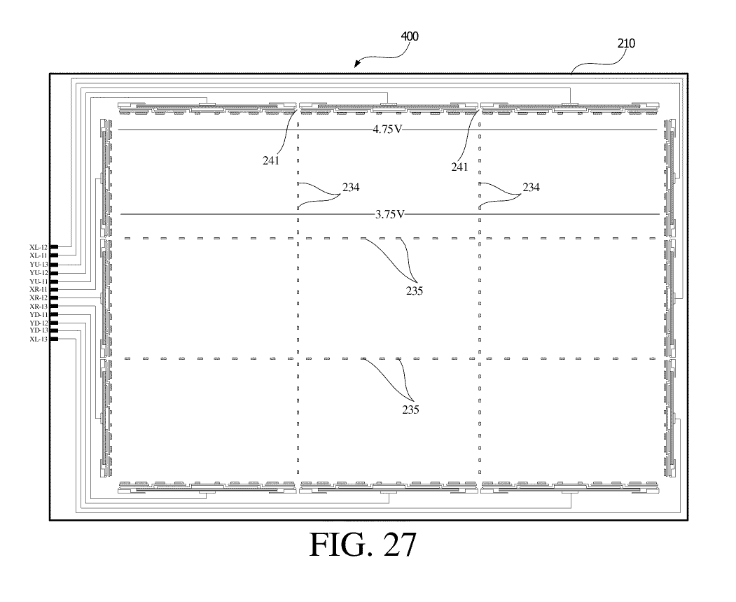

Please refer to FIG. 27, which is a schematic diagram of the second embodiment adopting the isolated dash line on the conductive layer of the touch panel with the matrix-type parallel electrode series 300 of the disclosure. FIG. 20 is the contrast in the design. Similarly, the increasing of the discontinuous isolated line in x-axis 234 and the discontinuous isolated line in y-axis 235 make the internal contact area of the conductive layer 210 is divided into nine blocks. The others are the same as mentioned above.

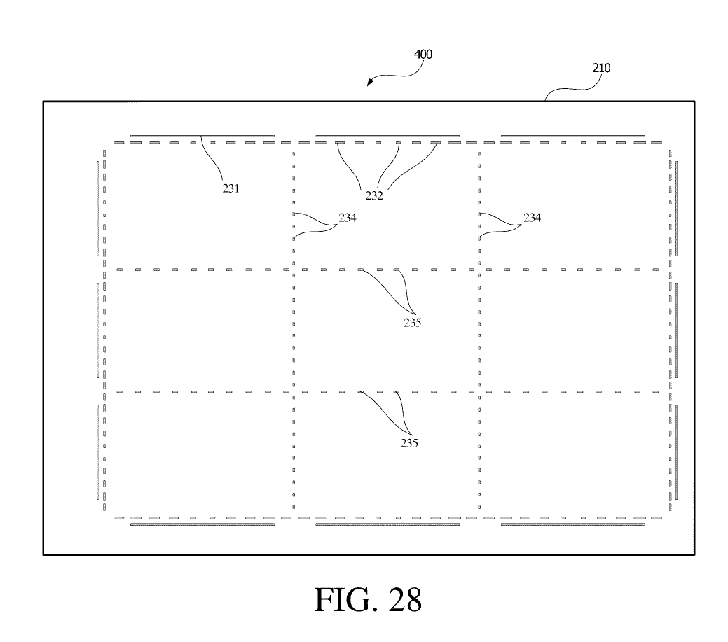

Please refer to FIG. 28, which is the etched diagram of the conductive layer of the embodiment in FIG. 27. It describes the fact that the electrode insulated segment 231, the discontinuous resistance segment 232, the discontinuous isolated line in x-axis 234 and the discontinuous isolated line in y-axis 235 can be formed simultaneously within the same process.

Multiple touch points can be detected by means of the touch panel with the matrix-type parallel electrode series of the disclosure. The detecting method is different from detection of the multiple touch points of project touch panel. It can be describes as following:

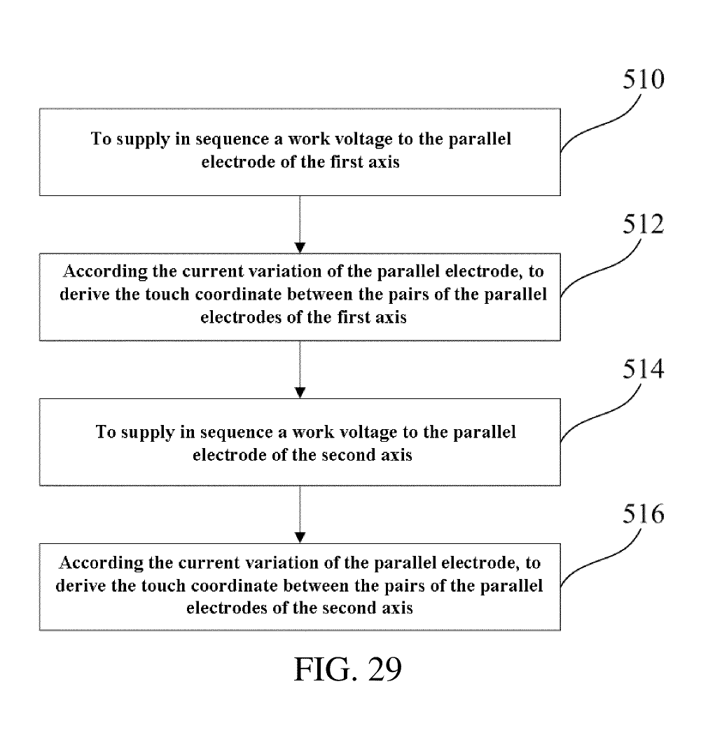

Please refer to FIG. 29, which is the flow chart of the detecting method of the touch panel with the matrix-type parallel electrode series of the disclosure. The first embodiment includes the following steps of:

Step 510: supplying in sequence a working voltage to the parallel electrode of the first axis.

Step 512: according to the current variation of the parallel electrode, obtaining the touch coordinate between the pairs of the parallel electrodes of the first axis. The touch point occurring within the pairs of the parallel electrode can be calculated precisely on the touch coordinate between the pairs of the parallel electrode by detecting the current variation.

Step 514: supplying in sequence a working voltage to the parallel electrode of the second axis.

Step 516: according to the current variation of the parallel electrode, obtaining the touch coordinate between the pairs of the parallel electrodes of the second axis. The touch point occurring within the pairs of the parallel electrode can be calculated precisely on the touch coordinate between the pairs of the parallel electrode by detecting the current variation.

When obtaining the coordinates of the touch points of the pairs of the parallel electrode in sequence, the number of the touch points and the touch coordinate can be calculated.

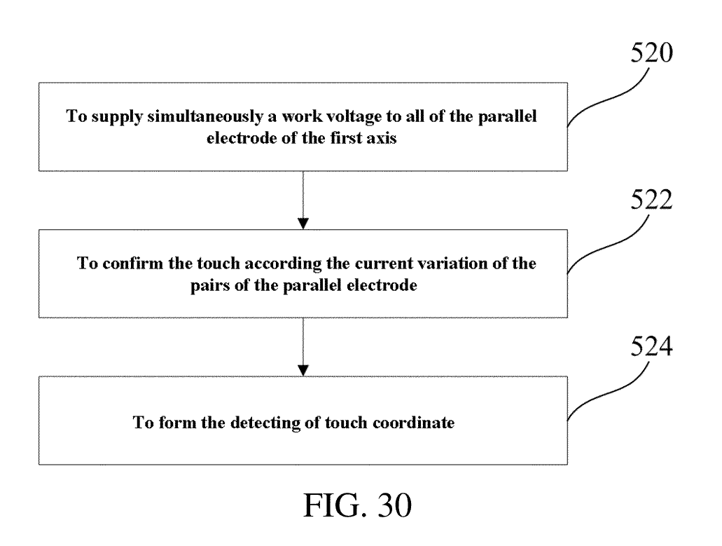

On the other hand, the scanning of single axis in apart of while instead of the scanning in sequence is not necessary in normal for purpose of power saving. After the touch confirmed, the precise detection of touch coordinate is formed. Therefore, the power consumption can be greatly decreased. Please refer to FIG. 30, which is the flow chart of the detecting method of the touch panel with the matrix-type parallel electrode series of the disclosure. The second embodiment includes the following steps of:

Step 520: supplying simultaneously a working voltage to all of the parallel electrodes of the first axis.

Step 522: confirming the touch according the current variation of the pairs of the parallel electrode.

Step 524: detecting the touch coordinate, that is, form the flow chart in FIG. 29.

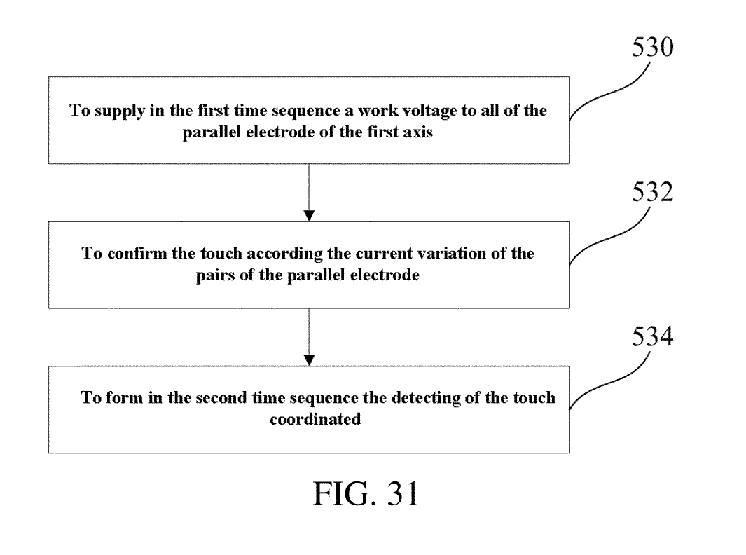

As mentioned above, to achieve the purpose of power saving, the scanning can be formed in a different time sequence. Please refer to FIG. 31, which is the flow chart of the detecting method of the touch panel with the matrix-type parallel electrode series of the disclosure. The third embodiment includes the following steps of:

Step 530: supplying in the first time sequence a working voltage to all of the parallel electrodes of the first axis.

Step 532: confirming the touch according the current variation of the pairs of the parallel electrode.

Step 534: performing in the second time sequence the detection of the touch coordinate.

The purpose of the providing of the first time sequence is to determine whether the touch is detected or not detected. Moreover, it is longer than the second time sequence for the purpose of saving power.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A touch panel with the matrix-type parallel electrode series, comprising:
a substrate;
a conductive layer, formed on the substrate, the conductive layer comprises an internal contact area;
at least one parallel electrode pair in x-axis, defined at least one detecting area in x-axis, formed on the edges of both sides in x-axis direction of the conductive layer in series and with symmetry, the at least one parallel electrode pair in x-axis are connected to a voltage controlled unit;
at least one parallel electrode pair in y-axis, defined at least one detecting area in y-axis, formed on the edges of both sides in y-axis direction of the conductive layer in series and with symmetry, the at least one parallel electrode pair in y-axis are connected to the voltage controlled unit; and
a plurality of series electrode chains, formed on the conductive layer, each of the two terminals of the plurality of series electrode chains is connected to either the two terminals of the at least one parallel electrode pairs in x-axis or the two terminals of the at least one parallel electrode pairs in y-axis and enclosed the internal contact area, each of the plurality of series electrode chains comprises a plurality of electrodes having an internal part, and a gap is formed between the plurality of electrodes;
wherein, the voltage controlled unit provides a voltage to the at least one parallel electrode pair in x-axis and the at least one parallel electrode pair in y-axis, and the voltage is transmitted by connecting the plurality of series electrode chain to the at least one detecting area in x-axis and the at least one detecting area in y-axis, and the touch detection is performed.

2. The touch panel with the matrix-type parallel electrode series according to claim 1, further comprising a plurality of discontinuous resistances chains, each of the plurality of discontinuous resistance chains is formed on the conductive layer by a plurality of discontinuous resistances, which are adjacent to the internal contact area, each of the plurality of discontinuous resistance chains and each of the plurality of series electrode chains are arranged in parallel and connected to each other, the plurality of discontinuous resistance chains compensate the voltage supplied by the plurality of series electrode chains.

3. The touch panel with the matrix-type parallel electrode series according to claim 2, further comprising a plurality of first equalized electrode chains, each of the plurality of first equalized electrode chains is formed on the conductive layer by a plurality of first equalized electrodes, which are uniformly arranged and adjacent to the internal contact area, each of the plurality of first equalized electrodes and each of the plurality of discontinuous resistances are arranged in parallel, connected to each other and used for equalizing the output voltage supplied by the plurality of discontinuous resistances.

4. The touch panel with the matrix-type parallel electrode series according to claim 3, further comprising a plurality of second equalized electrode chains, each of the plurality of second equalized electrode chains is formed on the conductive layer by a plurality of second equalized electrodes, which are uniformly arranged and adjacent to the internal contact area, located between two of the plurality of first equalized electrodes and used for equalizing the output voltage supplied by the plurality of first equalized electrode chain.

5. The touch panel with the matrix-type parallel electrode series according to claim 2, wherein each of the plurality of discontinuous resistance chains comprises a plurality of discontinuous insulated segments formed on the conductive layer, and the plurality of the discontinuous insulated segments are arranged seamlessly with the internal part of the plurality of series electrode chains.

6. The touch panel with the matrix-type parallel electrode series according to claim 3, wherein each of the plurality of discontinuous resistance chains comprises a plurality of discontinuous insulated segments formed on the conductive layer and the plurality of discontinuous insulated segments are arranged seamlessly with the plurality of first equalized electrode chains.

7. The touch panel with the matrix-type parallel electrode series according to claim 3, wherein each of the plurality of discontinuous resistance chains comprises a plurality of discontinuous insulated segments formed on the conductive layer, and the plurality of discontinuous insulated segments are arranged seamlessly with the plurality of series electrode chains and the plurality of first equalized electrode chains.

8. The touch panel with the matrix-type parallel electrode series according to claim 3, wherein each of the plurality of first equalized electrodes comprises a horizontal part and a perpendicular part, each of the plurality of second equalized electrodes is linear and a pitch is formed due to the bottom part of the perpendicular part of the plurality of first equalized electrodes are arranged in parallel with the plurality of second equalized electrodes.

9. A touch panel with the matrix-type parallel electrode series, comprising:
a substrate;
a conductive layer, formed on the substrate, the conductive layer comprises an internal contact area, the conductive layer is divided into a plurality of touch areas by at least one discontinuous isolated line in x-axis and at least one discontinuous isolated line in y-axis;
a plurality of parallel electrode pairs in x-axis, formed on the edges of both sides in x-axis direction of the conductive layer in series and with symmetry, connected to a voltage controlled unit, defining the plurality of touch areas as a plurality of areas in x-axis with the at least one discontinuous isolated line in x-axis;
a plurality of parallel electrode pairs in y-axis, formed on the edges of both sides in y-axis direction of the conductive layer in series and with symmetry, connected to a voltage controlled unit, defining the plurality of touch areas as a plurality of areas in y-axis with the at least one discontinuous isolated line in y-axis; and
a plurality of series electrode chains, formed on the conductive layer, each of the two terminals of the plurality of series electrode chains is connected to either the two terminals of the plurality of parallel electrodes pairs in x-axis or the two terminals of the plurality of parallel electrodes pairs in y-axis and enclosed the internal contact area, each of the plurality of series electrode chains comprises a plurality of electrodes which possess an internal part and forms a gap between the plurality of electrodes;
wherein, the voltage controlled unit provides a voltage to the plurality of parallel electrode pairs in x-axis and the plurality of parallel electrode pairs in y-axis, and the voltage is transmitted by the plurality of series electrode chains to the plurality of areas in x-axis and the plurality of areas in y-axis, the touch detection is performed.

10. The touch panel with the matrix-type parallel electrode series according to claim 9, wherein the at least one discontinuous isolated line in x-axis and the at least one discontinuous isolated lines in y-axis are symmetrically formed with the plurality of series electrode chains.

11. The touch panel with the matrix-type parallel electrode series according to claim 9, further comprising a plurality of discontinuous chain of resistances, each of the plurality of discontinuous resistance chains is formed on the conductive layer by the plurality of discontinuous resistances, which is adjacent to the internal contact area, each of the plurality of discontinuous resistance chains and each of the plurality of series electrode chains are arranged in parallel and connected to each other, the plurality of discontinuous resistance chains compensate the voltage supplied by the plurality of series electrode chains.

12. The touch panel with the matrix-type parallel electrode series according to claim 11, further comprising a plurality of first equalized electrode chains, each of the plurality of first equalized electrode chains is formed on the conductive layer by a plurality of first equalized electrodes, which are uniformly arranged and adjacent to the internal contact area, each of the plurality of first equalized electrodes and each of the plurality of discontinuous resistances are arranged in parallel, connected to each other and used for equalizing the output voltage supplied by the plurality of discontinuous resistances.

13. The touch panel with the matrix-type parallel electrode series according to claim 12, wherein at least one discontinuous isolated line in x-axis and at least one discontinuous isolated line in y-axis are symmetrically formed with the plurality of first equalized electrode chains.

14. The touch panel with the matrix-type parallel electrode series according to claim 12, further comprising a plurality of second equalized electrode chains, each of the plurality of second equalized electrode chains is formed on the conductive layer by a plurality of second equalized electrodes, which are formed uniformly and adjacent to the internal contact area, located between the gaps of every two first equalized electrode and used for equalizing the output voltage supplied by each of the plurality of first equalized electrode chains.

15. The touch panel with the matrix-type parallel electrode series according to claim 14, wherein the at least one discontinuous isolated line in x-axis and the at least one discontinuous isolated line in y-axis are symmetrically formed with the plurality of first equalized electrode chains.

16. The touch panel with the matrix-type parallel electrode series according to claim 11, wherein each of the plurality of discontinuous resistance chains comprises a plurality of discontinuous insulated segments formed on the conductive layer, and the plurality of discontinuous insulated segments are arranged seamlessly with the internal part of the plurality of series electrode chains.

17. The touch panel with the matrix-type parallel electrode series according to claim 16, wherein each of the plurality of discontinuous resistance chains comprises a plurality of discontinuous insulated segments formed on the conductive layer, and the plurality of discontinuous insulated segments are arranged seamlessly with the plurality of first equalized electrode chains.

18. The touch panel with the matrix-type parallel electrode series according to claim 16, wherein each of the plurality of discontinuous resistance chains comprises a plurality of discontinuous insulated segments formed on the conductive layer, and the plurality of discontinuous insulated segments are arranged seamlessly with the plurality of series electrode chains and the plurality of first equalized electrode chains.

19. The touch panel with the matrix-type parallel electrode series according to claim 16, wherein each of the plurality of first equalized electrodes comprises a horizontal part and a perpendicular part, each of the plurality of second equalized electrodes is linear, and a pitch is formed due to the bottom part of the perpendicular part of the plurality of first equalized electrodes are arranged in parallel with the plurality of second equalized electrodes.

20. A touch detection method of the matrix-type parallel electrode series, the matrix-type parallel electrode series comprises a plurality of first axis parallel electrode pairs, a plurality of second axis parallel electrode pairs, which are used for detecting the touch coordinates of a first axis and a second axis, comprising the steps of:
supplying a working voltage sequentially to the plurality of the first axis parallel electrode pairs;
obtaining the touch coordinates of the first axis according to a detected signal variation within the plurality of the first axis parallel electrode pairs;
supplying the working voltage sequentially to the plurality of second axis parallel electrode pairs; and
obtaining the touch coordinate of the second axis according to the detected signal variation within the plurality of the second axis parallel electrode pairs.
